(19) United States
(12) Patent Application Publication
(10) Pub. No.: US 2007/0232390 A1
(43) Pub. Date: Oct. 4, 2007

(54) Gaming machine

(75) Inventor: Kazunobu Sato, Tokyo (JP)

Correspondence Address: ARENT FOX PLLC, 1050 CONNECTICUT AVENUE, N.W., SUITE 400, WASHINGTON, DC, 20036, US

(73) Assignee: Aruze Corporation

(21) Appl. No.: 11/730,633

(22) Filed: Apr. 3, 2007

(30) Foreign Application Priority Data
Apr. 3, 2006 (JP) 2006-102119

(51) Int. Cl. A63F 13/00

(52) U.S. Cl. 463/25

(57) ABSTRACT

The present invention provides a gaming machine which allows a player to positively participate in a game. Accordingly, the player can play the game with the sophisticated strategy and without getting bored. The gaming machine of the present invention includes a variable display group which selectively determines a base game and a bonus game by lottery processing based on a game start command from a player and displays a variable display image consisting of a plurality of symbols, an image control circuit which performs a display control of the symbol combination corresponding to the base game and the symbol combination corresponding to the bonus game determined by the lottery processing on the variable display group, and a microcomputer which, when the player wins the bonus game, can stock the winning state and, at the same time, when a stock release command is inputted from the player in a state that the bonus game is stocked, executes the stocked bonus game. The microcomputer, in executing the bonus game in response to the inputting of the stock release command, changes a content of the bonus game when a predetermined condition is established.

### BACKGROUND OF THE INVENTION

1. Field of the Invention

The present invention relates to a gaming machine such as a slot machine which is capable of performing a variable display of symbols arranged in a plurality of rows.

2. Description of the Related Art

Conventionally, there has been known a gaming machine which allows a player to play a game while variably displaying symbols in a plurality of rows formed on an outer periphery of a rotary reel. As the variable display device which is incorporated in such a gaming machine, there has been known a variable display device which changes the symbols by mechanically rotating an actual rotary reel or a variable display device which performs a variable display of symbols by rotating a virtual rotary reel on an image display device such as a liquid crystal display device or a CRT (Cathode Ray Tube). For example, JP-A-2004-57221 (counterpart U.S. patent application being issued as U.S. Pat. No. 6,893,018B1) discloses a video-reel gaming machine which performs an image display on a plurality of variable display devices (three reels in the vertical direction and three reels in the lateral direction thus nine reels in total). Here profits (for example, game mediums such as coins or medals) are given to a player based on predetermined awards corresponding to the combination of symbols to be displayed (combination of symbols arranged on a BET line or the like).

As the above-mentioned gaming machine, there has been known a gaming machine which possesses a function of performing a base game (also referred to as a primary game, a basic game) and a bonus game (also referred to as a secondary game, a special game, a second game). In general, the above-mentioned two gaming states are determined based on predetermined internal lottery processing or the like which is performed each time the game is started. When the bonus game is established, the player can obtain a larger profit (a larger quantity of playing mediums). Accordingly, the probability for establishing the bonus game based on the internal lottery processing is low and hence, the game gives an interest to the player playing the game thus preventing the player from being bored with the game.

In the above-mentioned manner, when the bonus game is established, the base game is readily shifted to the bonus game and, upon completion of the game, a large profit is given to the player in general. On the other hand, for example, JP-A-2005-21257 discloses a gaming machine in which, even when the player win the bonus game based on the internal lottery processing during the game, the gaming machine is controlled not to display the combination of symbols which win the bonus game and to stock the bonus game (also referred to as a stock machine). In such a gaming machine, when a predetermined condition is established, the stocked winning state is released thus allowing the player to receive a large profit.

As described above, with the gaming machine which offers the bonus game beside the base game, the player gradually feels monotonous as the player continuously plays the bonus game several times and hence, the player loses an interest in playing the bonus game per se. Further, even when the bonus game is stocked in the stock machine, the bonus game is released when a predetermined condition is established and hence, the player has to become passive in playing the game whereby the player who requires stimulation is not satisfied with the above-mentioned gaming machine and desires an advent of a novel gaming machine.

The present invention has been made in view of the above-mentioned drawbacks and it is an object of the present invention to provide a gaming machine which allows a player to positively participate in a game so that the player can play the game with sophisticated strategy without getting bored.

### SUMMARY OF THE INVENTION

To achieve the above-mentioned object, a first aspect of the present invention provides a gaming machine which includes: a display unit that is configured to display a plurality of symbols; an operation unit that allows a player to input commands; and a processor that is operable with the display unit and the operation unit to execute a base game by using the symbols, determine whether or not a bonus game is won based on a result of the base game, allow the bonus game to be stocked to be executed afterward when it is determined that the bonus game is won, accept a stock release command input by the player through the operation unit while the bonus game is stocked, provide the bonus game to the player when the stock release command is accepted, and change a content of the bonus game when a predetermined condition is established in executing the bonus game in response to inputting of the stock release command.

The gaming machine having the above-mentioned constitution provides a pattern of the base game and a pattern of the bonus game which gives the player a game value relatively advantageous for the player compared to the base game, and whether the gaming machine performs the base game or the bonus game which may be determined by the lottery processing means performed based on a game start command of the player. Further, the gaming machine includes the display unit which performs a variable display of a plurality of symbols, for example, a plurality of rotary reels having rows of symbols. Based on a result of the lottery processing means executed along with the starting of the game, the stop mode of the rotary reels (symbol combination) is determined.

Then, when the player wins the bonus game, the winning state is stocked. When the player inputs the stock release command to the gaming machine in a state that the bonus game is stocked, the stocked bonus game is executed. That is, the bonus game is not executed by the gaming machine side but is executed based on the will of the player (an inputting manipulation of a stock release signal) at timing that the player desires and hence, it is possible to provide the gaming machine which allows the player to positively participate in the game and to allow the player to enjoy the game with strategy and interest.

Further, in executing the stocked bonus game, when the predetermined condition is established, the content of the bonus game can be changed. This predetermined condition may be selected from various conditions including, for example, the number of times of the stocked bonus game, the number of inserted gaming mediums such as coins, a time from starting of the game to the present, the total number of times of executed game or the like. By setting such conditions, the bonus game which is executed when the stock release command is inputted thus increasing the interest and gaming properties of the game.

Further, the gaming machine having the above-mentioned constitution is also characterized in that the processor, in executing the stocked bonus game, changes the content of the bonus game to a high award bonus game which gives a quantity of gaming value far larger than a gaming value acquired based on the number of times of the stocked bonus game.

In such a gaming machine, when the predetermined condition is established and the stocked bonus game is executed, the game (high award bonus game) which can obtain the game value acquired based on the number of times of stocked bonus game or more can be executed. That is, by giving a merit to the player in executing the stocked bonus game based on the establishment of the predetermined condition, the player plays the game while aiming at such a high awards bonus game thus increasing the interest and gaming properties of the game.

Further, the gaming machine having the above-mentioned constitution is also characterized in that the processor is capable of informing the player of the establishment of the predetermined condition.

As described above, by informing the player of the establishment of the predetermined condition, the player can specifically grasp the timing that the player can obtain a large quantity of game value and hence, the player can input the stock release signal with strategy. To the contrary, when the gaming state control unit does not inform the player of the establishment of the predetermined condition, the player cannot preliminarily grasp whether the change of content is present or not with respect to the bonus game executed when the stock release signal is inputted and hence, the player can enjoy the game with an unexpected change of content of the game.

Further, the gaming machine having the above-mentioned constitution is also characterized in that the predetermined condition is constituted of a plurality of conditions and content of the bonus game is changed for every condition.

In such a gaming machine, the change of content of the bonus game which is executed when the bonus game is stocked three times and the change of content of the bonus game which is executed when the bonus game is stocked four times differ from each other. Accordingly, the player can determine whether the stock release should be performed or not and hence, the player can play the game with more sophisticated strategy and the interest and the game property of the game are further enhanced.

According to the present invention, a player can positively participate in the game and hence, the gaming machine can allow the player to take the sophisticated strategy in advancing the game and, at the same time, can prevent the player from getting bored with the game.

Additional objects and advantages of the invention will be set forth in the description which follows, and in part will be obvious from the description, or may be learned by practice of the invention. The objects and advantages of the invention may be realized and acquired by means of the instrumentalities and combinations particularly pointed out hereinafter.

### BRIEF DESCRIPTION OF THE SEVERAL VIEWS OF THE INVENTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

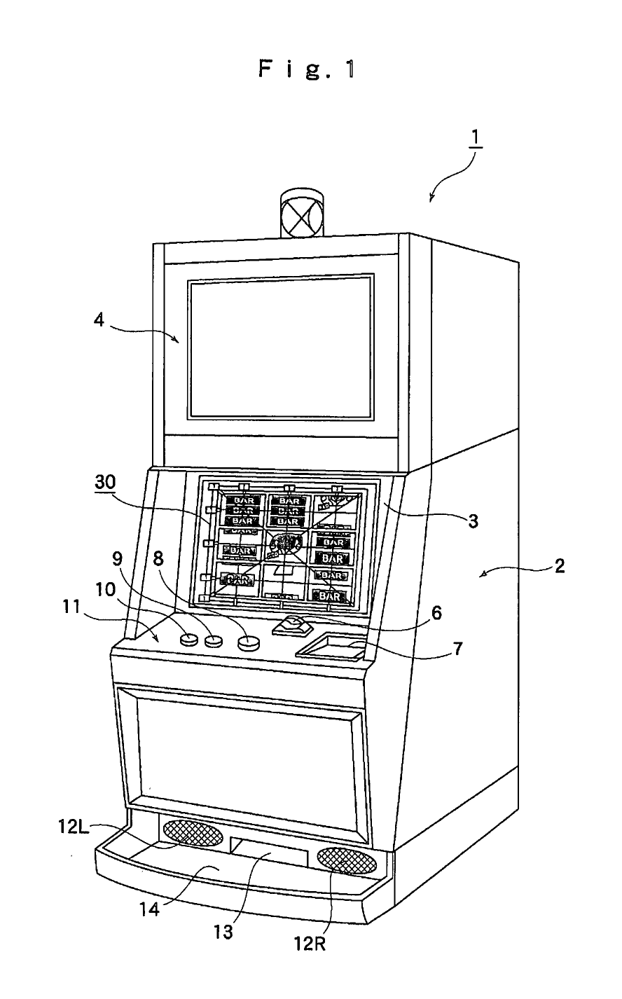

FIG. 1 is a perspective view showing an appearance of a slot machine which constitutes a gaming machine according to one embodiment of the present invention;

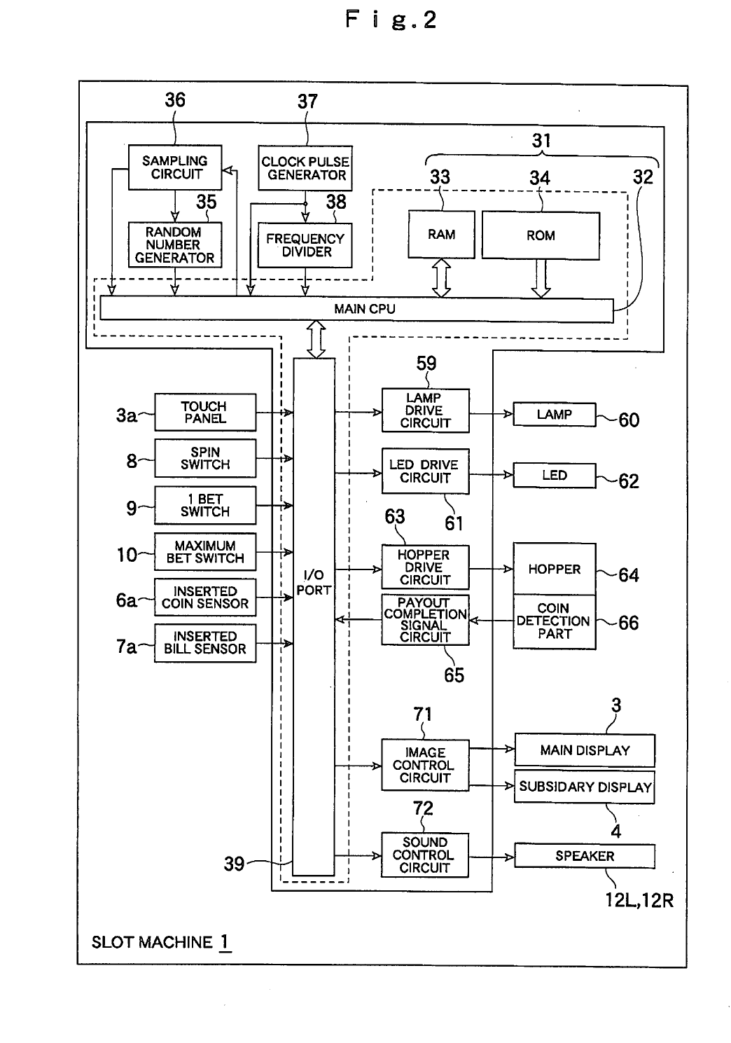

FIG. 2 is a block diagram schematically showing a control system of the slot machine;

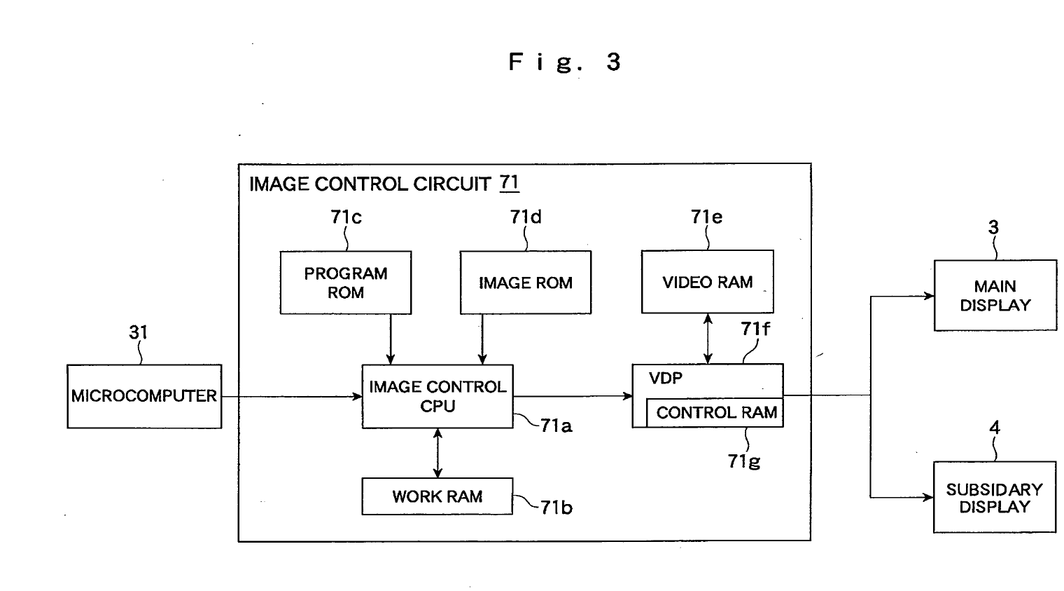

FIG. 3 is a block diagram showing one example of the inner constitution of an image control circuit;

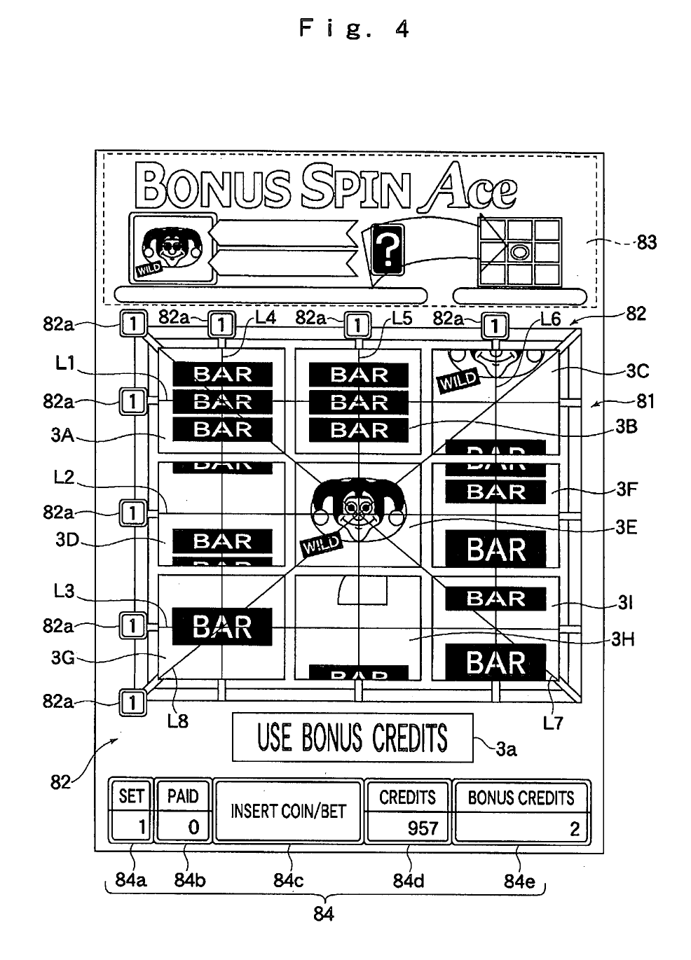

FIG. 4 is a view showing one example of a display screen of a main display;

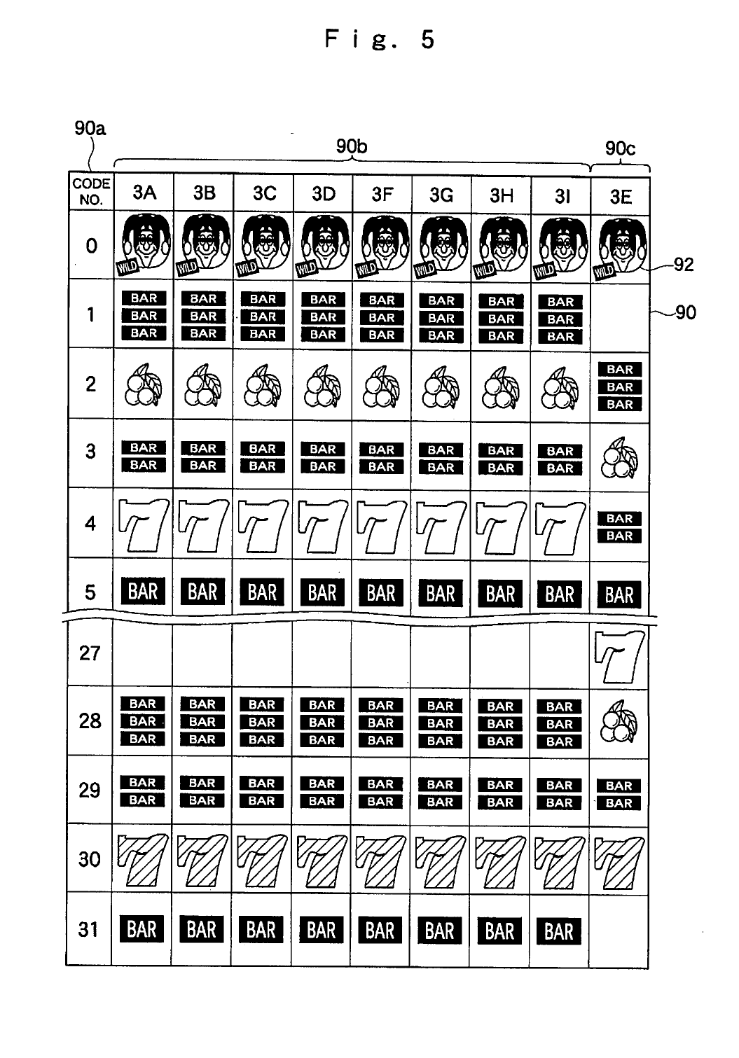

FIG. 5 is a view showing an arrangement table of respective display areas of the slot machine;

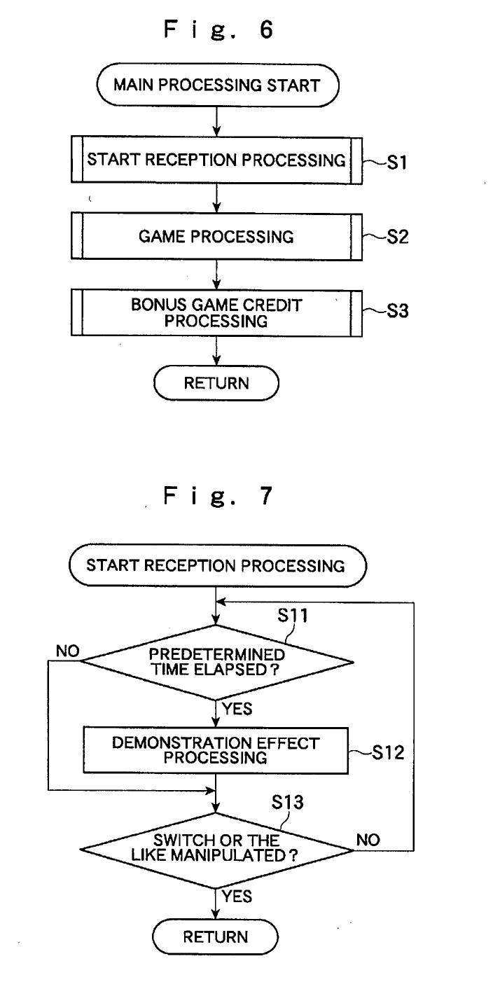

FIG. 6 is a flowchart showing a game progress of the slot machine (first flowchart);

FIG. 7 is a flowchart showing a game progress of the slot machine (second flowchart);

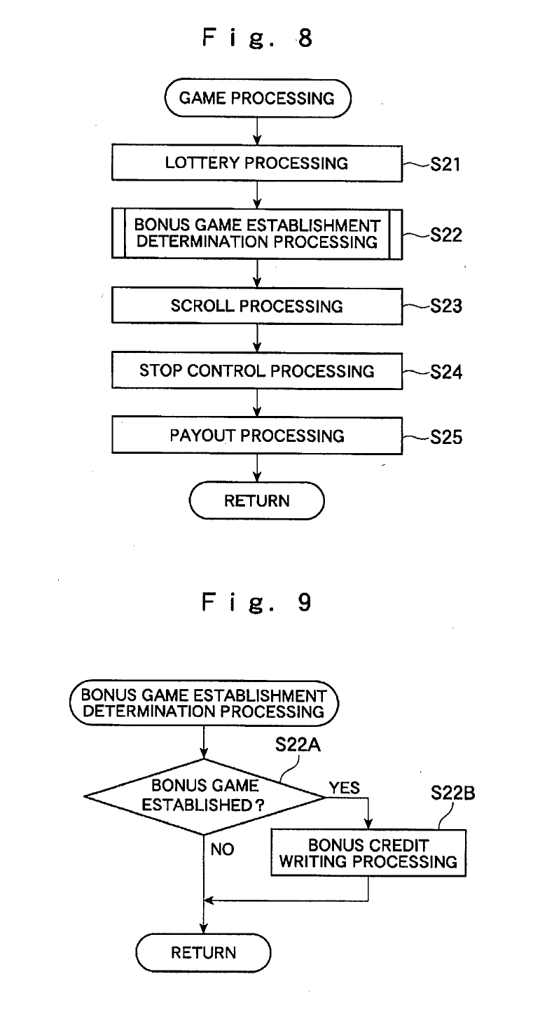

FIG. 8 is a flowchart showing a game progress of the slot machine (third flowchart);

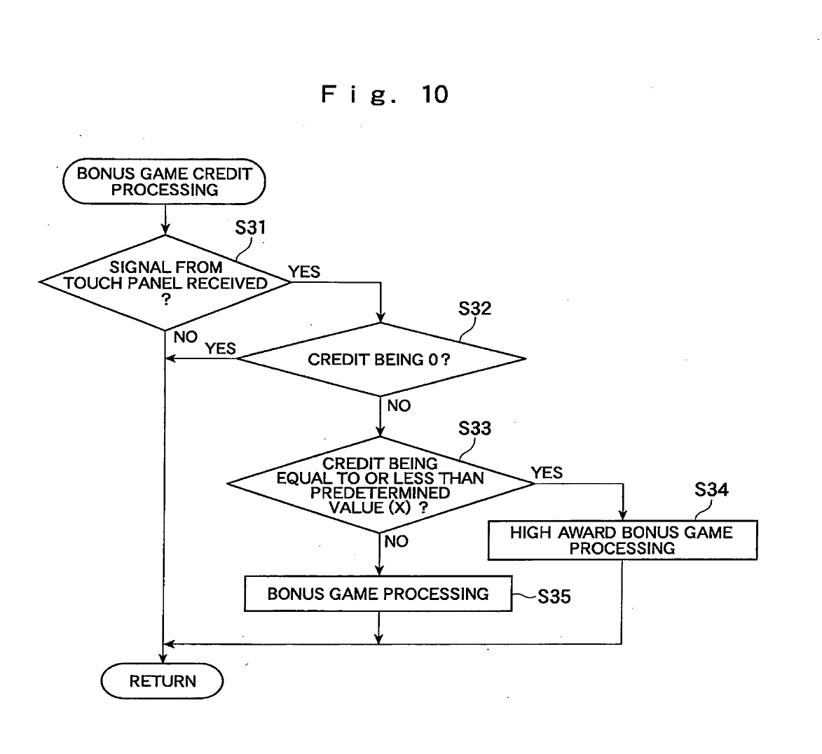

FIG. 9 is a flowchart showing a game progress of the slot machine (fourth flowchart);

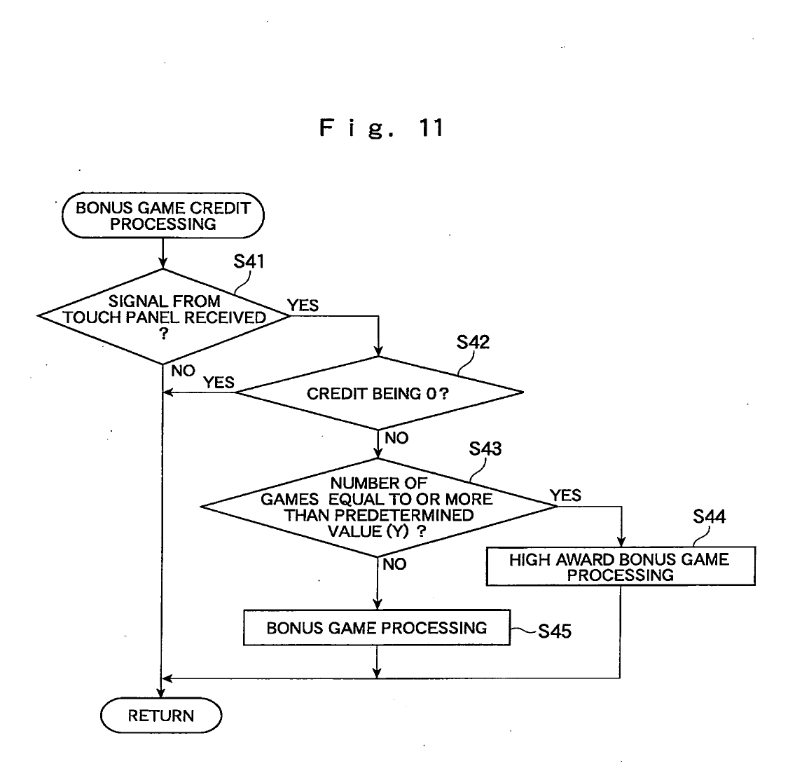

FIG. 10 is a flowchart showing a game progress of the slot machine (fifth flowchart);

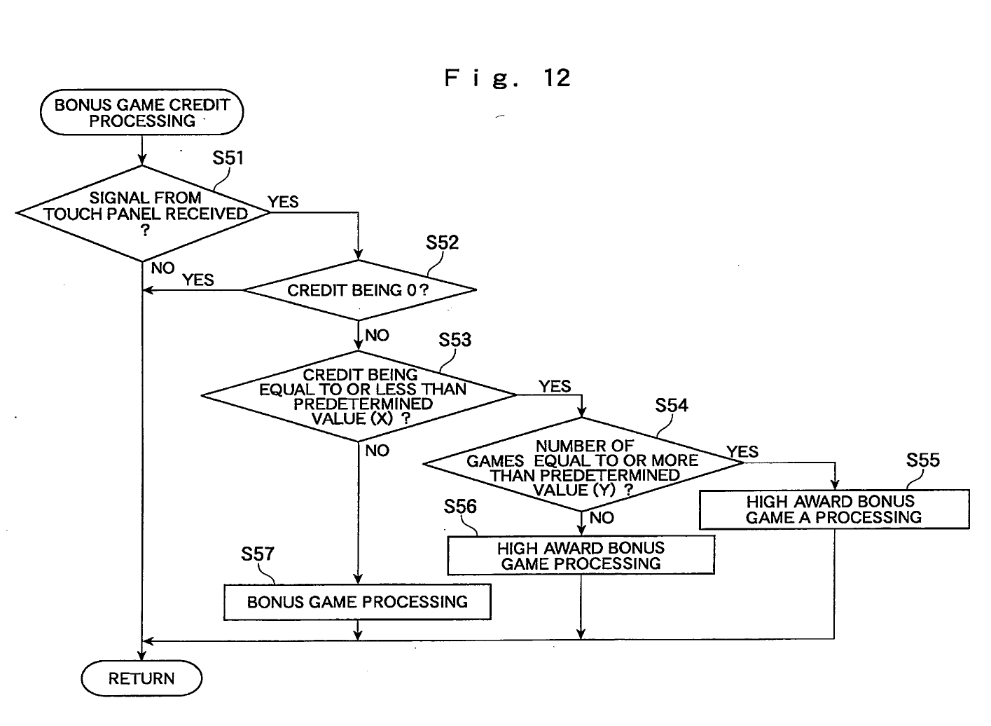

FIG. 11 is a flowchart showing steps of a second embodiment of bonus game credit processing; and

FIG. 12 is a flowchart showing steps of a third embodiment of bonus game credit processing.

### DESCRIPTION OF THE PREFERRED EMBODIMENTS

Hereinafter, one embodiment of the gaming machine according to the present invention is explained in conjunction with the attached drawings.

FIG. 1 is a perspective view showing the whole constitution of a slot machine which constitutes one example of the gaming machine. A slot machine 1 includes a cabinet 2 and a main display 3 which includes a liquid crystal display device is mounted on a front surface of the cabinet 2. The slot machine 1 also mounts a subsidiary display 4 which also includes a liquid crystal display device on an upper side portion of the main display 3.

The main display 3 constitutes a variable display device which performs a display of a rotary reel in a pseudo manner as described later. A screen of the main display 3 is configured to have a symbol display portion 30 that displays a group of symbol display areas. The symbol display portion 30 includes a plurality of variable display areas (in this embodiment, nine variable display areas in total in which three variable display areas are arranged in the vertical direction and three variable display areas are arranged in the lateral direction 3A, 3B, 3C, 3D, 3E, 3F, 3G, 3H, 3I; see FIG. 4) and the plurality of variable display areas 3A to 3I is configured to be viewed by the player as a mass.

Here, the main display 3 is constituted as a display unit which includes a light-transmitting touch panel 3a. The main display 3 may be configured to receive various input commands when the player touches the touch panel 3a. In this embodiment, the touch panel 3a is arranged below the nine variable display areas (see FIG. 4) and, as described later, when the player touches the touch panel 3a in executing stocked bonus game, the main display 3 receives a command for executing the stocked bonus game (stock release command).

In the main display 3, using a gaming state control unit described later, the base game and the bonus game which gives the player a game value relatively advantageous for the player compared to the base game are executed. In this case, in either one of the base game and the bonus game, a scroll display of images in which a plurality of symbols seemingly moves downwardly from above to below (a reel image which display mechanical reels which are seemingly rotated) is displayed on the variable display areas 3A to 3I.

Here, in this embodiment, nine variable display areas 3A to 3I are arranged in the symbol display portion 30 and hence, eight pay lines in total (L1 to L8) for determining the symbol combination are constituted of three lines extending in the longitudinal direction on the variable display areas 3A to 3I, three lines extending in the lateral direction on the variable display areas 3A to 3I, and two lines extending in the diagonal directions on the variable display areas 3A to 3I. (see FIG. 4).

The subsidiary display 4 which is mounted on the main display 3 displays an image related to the game such as a payout table or an explanation of the game (for example, explanation of contents of the game or the like). It is needless to say that this portion may be formed by incorporating a panel describing the contents of the game.

Further, an approximately horizontal pedestal portion 11 is formed below the main display 3. A coin insertion slot 6, a bill insertion slot 7, a spin switch 8, a 1BET switch 9 and a maximum BET switch 10 are formed on the pedestal portion 11. Here, the bill insertion slot 7, the spin switch 8, the 1BET switch 9 and the maximum BET switch 10 constitute an operation unit.

Here, the player inserts a game medium such as a coin or a medal (hereinafter referred to as coin) into the coin insertion slot 6 for betting on the game. The coin insertion slot 6 includes an inserted-coin sensor which detects an inserted coin and outputs a detection signal (see FIG. 2). Further, the player inserts a bill into the bill insertion slot 7. The bill insertion slot 7 includes an inserted-bill sensor 7a which detects an inserted bill and outputs a detection signal (see FIG. 2). The spin switch 8 is provided for allowing the player to perform the manipulation to start a slot game. Upon manipulation of the spin switch, the scroll display image of symbols is displayed in the variable display areas 3A to 3I. The 1BET switch 9 is provided for allowing the player to bet one coin by one manipulation. Then, the maximum BET switch 10 is provided for allowing the player to bet the maximum number of coins which the player can in one game by one manipulation.

Further, the slot machine 1 forms a coin payout opening 13 and a coin receiving portion 14 for storing paid-out coins on a bottom portion of the cabinet 2. Further, the slot machine 1 mounts speakers 12L, 12R on left side and the right sides of the slot machine 1 respectively such that the speakers 12L, 12R sandwich the coin payout opening 13.

FIG. 2 is a block diagram which schematically shows a control system of the slot machine 1. As shown in FIG. 2, the slot machine 1 is constituted of a plurality of constitutional elements including a microcomputer 31 which forms a main part of the slot machine 1.

The microcomputer 31 includes a main CPU (Central Processing Unit) 32 which constitutes a controller of the present invention, a RAM (Random Access Memory) 33 and a ROM (Read Only Memory) 34.

The main CPU 32 is operated in accordance with a program stored in the ROM 34, receives signals from a touch panel and the coin insertion slot 6 (inserted coin sensor 6a), the bill insertion slot 7 (inserted bill sensor 7a), the spin switch 8, the 1BET switch 9, the maximum BET switch 10 which are mounted on the pedestal portion 11 via an I/O port 39, and performs an operation control of the whole slot machine 1. To be specific, the ROM 34 stores a program which the main CPU 32 executes and permanent data. The RAM 33 stores data and a program which are used when the CPU 32 is operated in accordance with the operational program of the ROM 34. For example, the RAM 33 temporarily stores a random number value which is sampled by a sampling circuit 36 described later after the game is started or stocks the number of times that the player wins the bonus game. That is, the main CPU 32, the RAM 33 and the ROM 34 work as a processor which possesses functions of a game control unit and a gaming state control unit which controls a gaming state of the slot machine 1.

Further, the slot machine 1 includes a random number generator 35, the sampling circuit 36, a clock pulse generator 37, and a frequency divider 38 all of which constitute a lottery processing means. The random number generator 35 is operated in response to an instruction from the main CPU 32 and generates a random number in a predetermined range. The sampling circuit 36, in response to an instruction from the main CPU 32, samples an arbitrary random number out of the random numbers generated by the random number generator 35 and inputs the sampled random number to the main CPU 32. The clock pulse generation circuit 37 generates a reference clock for operating the main CPU 32, and the frequency divider 38 inputs a signal which is formed by dividing the reference clock by a predetermined cycle to the main CPU 32.

Further, the slot machine 1 includes a lamp driving circuit 59, a lamp 60, an LED driving circuit 61, an LED 62, a hopper driving circuit 63, a hopper 64, a payout completion signal circuit 65 and a coin detection portion 66. Further, the slot machine 1 includes an image control circuit 71 which performs a control display of an image to be displayed on the main display 3 and the subsidiary display 4, and a sound control circuit 72 which performs a control of a sound to be generated from the speakers 12L and 12R.

The lamp driving circuit 59 outputs a signal for turning on the lamp 60 to the lamp 60 and allows the lamp 60 to flicker during the execution of the game so as to perform a game effect. The LED driving circuit 61 controls a flickering display of the LED 62 which performs a credit number display, an acquired number display or the like. The hopper driving circuit 63 drives the hopper 64 in accordance with the control of the main CPU 32, and the hopper 64 performs a coin payout operation and pays out the coin in the coin payout opening 13.

The coin detection portion 66 counts the number of coins paid out by the hopper 64 and transmits data on a counted number value to a payout completion signal circuit 65. The payout completion signal circuit 65 inputs data on the number value of the coins from the coin detection portion 66 and inputs, when the number value reaches data on the set number, a signal which informs the completion of payout of coins to the main CPU 32.

The image control circuit 71 possesses a function of a display control means and controls image displays on the main display 3 and on the subsidiary display 4 respectively thus allowing the main display 3 and the subsidiary display 4 to display various images such as symbol images. The image control circuit 71 includes, as shown in FIG. 3, an image control CPU 71a, a working RAM 71b, a program ROM 71c, an image ROM 71d, a video RAM 71e and a VDP (Video Display Processor) 71f.

The image control CPU 71a determines images to be displayed on the main display 3 and the subsidiary display 4 (symbol images or the like) in accordance with the image control program which is preliminarily stored in the program ROM 71c based on parameters set by the microcomputer 31. The working RAM 71b is constituted as a temporary storing means when the image control CPU 71a executes the image control program. The program ROM 71c stores an image control program, various selection tables and the like. The image ROM 71d stores dot data for forming an image. The dot data contains data on various symbol images in this embodiment.

Further, the video RAM 71e is constituted as a temporary storing means when an image is formed by the VDP 71f. In this case, the VDP 71f includes a control RAM 71g, forms images corresponding to content of the display of the main display 3 and the subsidiary display 4 which are determined by the image control CPU 71a, and outputs the respective formed images to the main display 3 and the subsidiary display 4.

The sound control circuit 72 outputs sound signals for outputting sounds from the speakers 12L, 12R to the speakers 12L, the 12R. From the speakers 12L, 12R, for example, a sound for making the game exciting is outputted at an appropriate time after the game is started.

FIG. 4 is a view showing a display example of a display screen of the main display 3. In this embodiment, the main display 3 displays a reel display portion 81, a pay line display portion 82, an upper display portion 83 and a lower display portion 84.

The variable display areas 3A to 3I on which the symbols are to be displayed are provided to the reel display portion 81 in a 3×3 matrix array. On the display areas 3A to 3I, the variable display is performed to allow reel images on which a plurality of kinds of symbols is depicted is displayed in a rotatable manner. After the rotary display of the reel images is performed for a predetermined period, the image processing is performed such that a symbol which is selected as a stop symbol is displayed on an approximate center thereof.

The area including a left side and an upper side of the reel display portion 81 includes a pay line display portion 82 which includes a BET number display portion 82a for displaying the number of bets which are made on respective activated lines of the game (pay lines) L1 to L8. Here, in the slot machine 1 of this embodiment, the number of pay lines is eight, and the pay lines includes L1, L2 and L3 which extend in the vertical direction, L4, L5 and L6 which extend in the lateral direction and L7 and L8 which extend in the diagonal direction. The whole lines L1 to L8 are configured to be activated by one BET. Here, when a predetermined combination of symbols is arranged on any one of the pay lines L1 to L8, an award corresponding to the content of the combination of symbols are paid out to the player.

The upper display portion 83 is formed on the reel display portion 81 and the pay line display portion 82. The upper display portion 83 is constituted of a name and a logo mark of the slot machine 1, a mark designed to indicate how to play the game or the like. Further, below the reel display portion 81, the lower display portion 84 is formed. The lower display portion 84 is constituted of abet number (BET) display portion 84a, an acquired number (PAID) display portion 84b, a character information display portion 84c, a credit number (CREDITS) display portion 84d and a stocked bonus game number display portion 84e.

The bet number display portion 84a displays the number of coins which are bet on one game, and the acquired number display portion 84b displays the number of coins acquired by one game. The character information display portion 84c displays character information showing a present state of the game and, when the game assumes a bonus gaming state, for example, displays character information informing the state. The credit number display portion 84d displays the number of coins which are credited at the moment. Then, the stocked bonus game number display portion 84e displays the number of times of stocked bonus game.

In the example shown in FIG. 4, the stocked bonus game number display portion 84e displays the number of the bonus games being stocked under a title “BONUS CREDITS”.

32 symbols which are arranged in a predetermined order are cyclically displayed in a scroll display on the respective display areas 3A to 3I of the reel display portion 81 and hence, the player recognizes the scroll display as if mechanical reels are rotated so as to change the symbols.

The symbols which are subjected to a stop display on the respective display areas 3A to 3I of the reel display portion 81 are determined in the following manner, for example.

When the above-mentioned main CPU 32 detects the starting manipulation of the player (for example, the manipulation of the spin switch 8), upon receiving the detection (that is, based on the starting of game), the main CPU 32 instructs the random number generator 35 to generate random numbers within a predetermined range. Further, the main CPU 32 instructs the sampling circuit 36 to sample an arbitrary random number from the random numbers generated by the random generator. When the random number is sampled, the main CPU 32 sets the random number in a search key to consult with a symbol determination table not shown in the drawing (a table which stores correlation between code numbers of the symbols and random numbers) which is stored in the ROM 34 and acquires the corresponding code number of the symbol corresponding to the random number.

Next, the main CPU 32 sets the acquired code number in the search key and consults with a stopping table 90 shown in FIG. 5 and searches stopping symbols to be subjected to the stopping display with respect to the respective variable display areas 3A to 3I.

The stopping table 90 is, as shown in FIG. 5, a table which includes code numbers 90a, first symbol areas 90b and second symbol areas 90c which store symbols corresponding to the respective code numbers. The code number is set in the search key to search the code number area 90a and hence, the suitable symbols can be searched with respect to the respective variable display areas 3A to 3I.

The first symbol areas 90b and the second symbol areas 90c register the respective symbols corresponding to the respective code numbers from “0” to “31”. That is, the first symbol area 90b registers the stopping symbols to be displayed on the variable display areas 3A to 3D, 3F to 3I except for the center variable display area 3E, while the second symbol area 90c registers the stopping symbol to be displayed on the center variable display area 3E. Then, the slot machine 1 performs such series of operations, that is, sampling of random numbers and searching of the symbol determination table and the stopping table 90 nine times in total on the respective variable display areas 3A to 3I. That is, the table search is performed a number of times which corresponds to the number of variable display parts and the stopping symbols on the variable display areas 3A to 3I are determined.

Here, with respect to the symbols on which the stopping display is performed, an award combination (number of coins to be paid out) is preliminarily determined by a payout table in accordance with the combination of symbols arranged on the above-mentioned pay lines L1 to L8.

In this embodiment, a symbol (Wild joker) 92 in the second symbol area 90c which corresponds to the code number “0” is set as an advantage symbol. The Wild joker 92 informs the player that with this advantageous symbol, the player can acquire larger awards than other symbols. As shown in FIG. 5, the Wild joker is constituted by combining an image showing a face of a joker and a character string of “Wild”. To be more specific, as shown in FIG. 4, when the stopping display of the Wild joker 92 is performed on the center variable display area 3E, the player is informed of the bonus game which applies the game value relatively advantageous to the player. It is needless to say that various modifications can be made with respect to the method for informing the establishment of the bonus game (symbol combination).

Here, in the arrangement table shown in FIG. 5, the joker symbol which is positioned at “0” is a special symbol which is treated as any one of other symbols and also is a so-called wild symbol (almighty symbol) Accordingly, when the joker symbol is stopped on any one of the display areas 3A to 3I, the combination of symbols which agrees with the award combination is liable to be easily established on the pay lines L1 to L8. That is, the joker symbol is also a symbol which is advantageous for awards.

In the slot machine 1, as described above, depending on a result of the lottery processing which is executed when the player performs the starting manipulation (for example, the manipulation of the spin switch 8), the player wins either the base game or the bonus game. In this case, when player wins the bonus game, the bonus game is automatically stocked. The stocked bonus game can be executed at arbitrary timing based on the player's intension.

A mode of the bonus game executed in the slot machine is not particularly limited. However, in this embodiment, the player is guaranteed to perform a free game predetermined times (for example, 10 times). To be specific, during the bonus game, the free game allows the player to play the game without inserting a coin or pushing the bet button. That is, when the game is shifted to the bonus game, the player can play such a free game predetermined times (for example, 10 times) and hence, during the bonus game, the player can receive the payout of the coins without spending coins or credit numbers whereby the player becomes extremely advantageous in the acquisition of coins.

In the above-mentioned manner, when the player wins by the lottery processing, the bonus game is not immediately executed but is stocked, and the stocked bonus game can be executed at any arbitrary timing based on the intention of the player (the manipulation of the touch panel 3a by the player). Here, the gaming state control unit performs a control such that the content of the bonus game is changed when the predetermined condition is established.

In this embodiment, the predetermined condition is defined by the number of times of the stocked bonus game, and the different bonus game is executed under the condition that the player stocks the bonus game a predetermined number of times (X times).

For example, the different bonus game may be a game which gives the player a privilege to acquire a far larger quantity of profit than a profit which the player can acquire by executing the bonus game X times in a usual manner.

Such a privilege may be given to the player in the following manner. For example, when the bonus game is stocked three times, the player can obtain the privilege which gives the player to perform the substantially equal bonus game for one more time (+1 time) in addition to three times (four times of bonus game in total), or the privilege which, in executing the bonus game stocked three times, gives the player the larger quantity of awards in the bonus game, the privilege that the number of times of the free game that the player can perform is increased or the like. Alternatively, the player can acquire the privilege in which although the number of times of the bonus game is decreased (decreased to one time or two times), the player can play a bonus game with extremely large awards each time. Hereinafter, the game executed with such a privilege is referred to as a “high award bonus game”.

Then, such a high award bonus game is, as described above, executed when the player touches the touch panel. That is, the player can play the high award bonus game based on his free intension. Here, when the player touches the touch panel 3a in spite of the fact that the condition that the number of times of the stocked bonus game has not yet reached X times (less than X times), such a high award bonus game is not executed and the normal bonus game is executed the number of times of the stocked bonus game.

The player may be informed of the establishment of the above-mentioned predetermined condition. For example, at a point of time that the number of times of the stocked bonus game reaches X times, the character information which informs the player of the establishment of the predetermined condition may be displayed on the character information display portion 84c. Alternatively, the player may be informed of the establishment of the predetermined condition by flickering of a lamp, the generation of sounds or the like.

In the embodiment, the main CPU 32 of the microcomputer 31 performs the processing to determine whether the condition to shift the base game to the bonus game is established or not for every one game. When the condition to shift the base game to the bonus game is established, as a state ready for shifting to the bonus game, the bonus game stock information is written in the working region of the RAM 33. In the above-mentioned manner, the stopping of the joker symbol 92 at the variable display area (center reel) 3E becomes the condition for establishing the bonus game.

Next, the control method of the slot machine 1 according to this embodiment is explained.

FIG. 6 to FIG. 10 are flowcharts showing one example of steps of progress of the game in the above-mentioned slot machine 1. Here, in the flowcharts explained hereinafter, step is abbreviated as S. Further, the following processing is executed by the main CPU 32 based on information on the slot game of the program stored in the ROM 34 and the RAM 33.

When the main processing starts, the slot machine 1 (to be more specific, the main CPU 32) executes the start reception processing (S1). In this processing, the switches such as the inserted coin sensor 6a, the inserted bill sensor 7a, the touch panel 3a, the spin switch 8, the 1 BET switch 9, the maximum BET switch 10 are manipulated and signals outputted from the switches are received by the main CPU 32. At a point of time that the signals outputted from the respective switches are received, the game is started.

An example of specific processing steps of the above-mentioned start reception processing is explained in conjunction with the flowchart shown in FIG. 7.

Upon starting of the start reception processing, first of all, the main CPU 32 determines whether a predetermined time (for example, 15 seconds) elapses or not (S11). Here, when the main CPU 32 determines that the predetermined time has not yet elapsed (S11, NO), the processing advances to S13 without performing any operation. When the main CPU 32 determines that the predetermined time has elapsed (S11, YES), in S12, a demonstration effect is performed on the main display 3 or the subsidiary display 4 and, thereafter, the processing advances to S13. Here, when the main CPU 32 determines that the manipulation of the above-mentioned switches is not performed (S13, NO), the processing returns to S11 and the above-mentioned processing is repeated. When the main CPU 32 determines that the switches are manipulated (S13, YES), the processing returns to the main processing shown in FIG. 6 even in the midst of the demonstration effect and the game processing in step 2 is executed.

When the above-mentioned start reception processing in S1 finished, the game processing is executed (S2). That is, the CPU 32 waits for the betting of the player, and starts the game processing by completing the start reception processing when the player inserts some coins for betting one game through the coin insertion opening 6 or when the player manipulates the spin switch 8 by manipulating the bet button when a credit remains.

This game processing is executed in accordance with the flowchart shown in FIG. 8. That is, when the start reception processing is finished, the main CPU 32 performs the lottery processing (S21). This lottery processing is executed in response to the inputting of a signal from the spin switch 8, and the main CPU 32 samples one random number by way of a random number sampling circuit 36. Next, the sampled random number is compared with a random number value classification table (not shown in the drawing) which describes the correspondence relationship between the preliminarily prepared random numbers and winning combinations (including losing combinations) and determines the winning combination corresponding to the sampled random number. A cord No. corresponding to symbols (stop symbols) which are displayed in respective display areas 3A to 3I is correlated with the determined winning combination, and the main CPU 32 determines the symbols (stop symbols) which are displayed on the respective display areas 3A to 3I of the main display 3 by reference to the table shown in FIG. 5. That is, in determining the stop symbols, the random number transmitted to the main CPU 32 from the above-mentioned sampling circuit 36 is used. Further, the main CPU 32 is operated as the determination means and executes the bonus game establishment determination processing in which the bonus game shifting condition is established or not based on the sampled random number (S22).

In this bonus game establishment determination processing, as shown in the flowchart in FIG. 9, the CPU 32 determines whether the bonus game is established or not (S22A). If the bonus game is established, the CPU 32 accesses the work area of the RAM 33 and updates credit information that indicates a number of times the bonus game is established (S22B) and executes the scroll processing in S23 shown in FIG. 8. Further, when the bonus game is not established, the CPU 32 executes the scroll processing in S23 shown in FIG. 8 as it is (S22A, NO).

After the above-mentioned bonus game determination processing in S22 is finished, the scroll processing is successively executed (S23). In this scroll processing, as described above, the symbols displayed in the respective display areas 3A to 3I of the main display 3 are subject to the image processing as if mechanical reels are rotated. This processing is performed by allowing the main CPU 32 controls the above-mentioned image control circuit 71.

Then, succeeding to the scroll processing in S23, upon receiving a result of the lottery processing in the above-mentioned S21, the stop control processing for stopping images during scrolling is performed to display predetermined stop symbols on the respective display areas 3A to 3I of the main display 3 (S24). This stop control processing is also performed by allowing the main CPU 32 to control the image control circuit 71.

Here, in the above-mentioned lottery processing in S21, when the bonus game is established, the main CPU 32 determines the symbol arrangement of the stop symbols in the respective display areas 3A to 3I to inform the player of the establishment of the bonus game in step S24. To be more specific, when the main CPU 32 determines that the bonus game is established using the random number value transmitted to the main CPU 32 from the sampling circuit 36 and the random number value classification table (not shown in the drawing) which is stored in the ROM 34, the main CPU 32 performs a stop control such that a joker symbol 92 is displayed on the center reel 3E with respect to the symbol arrangement of the stop symbols of the respective display areas 3A to 3I (when the bonus game is established, the code number “0” of the second symbol area 90c is determined). That is, in this embodiment, by displaying the joker symbol 92 on the center reel 3E, the main CPU 32 informs the player of the establishment of the bonus game shifting condition.

Then, subsequent to the stop control processing in step S24, payout processing of coins acquired by the game is executed (S25) and the game processing is finished. Subsequent to the game processing, the bonus game credit processing in the flow chart shown in FIG. 6 is executed (S3). This processing is executed when the player touches the above-mentioned touch panel 3a. Unless the player touches the touch panel 3a, the bonus game credit processing is not executed and the processing subsequently returns to start reception processing in step S1 (S31 in FIG. 10, NO).

To the contrary, as shown in the flowchart in FIG. 10, in the bonus game credit processing, when the player touches the above-mentioned touch panel 3a, the bonus game is executed based on such a touching operation (S31, YES). In this case, even when the player touches the touch panel 3a, provided that the bonus game is not credited, the bonus game credit processing is not executed and the processing is shifted to the processing S1 in FIG. 6 (S32, YES).

With respect to the bonus game credit processing, in the above-mentioned bonus game establishment determination processing, if the number of times of bonus game establishment (numbers of times of credit (X)) written in the RAM 33 is equal to or above a predetermined value, that is, if the predetermined condition is established (S33, YES), the above-mentioned high award bonus game processing which is a bonus game whose content is changed from a content of a usual bonus game is executed (S34). On the other hand, when the predetermined condition is not established (S33, NO), the content of the bonus game is not changed from the content of the usual bonus game and the usual bonus game corresponding to the number of times of credit is executed (S35).

Here, in the above-mentioned bonus game (including the high award bonus game), the payout processing is sequentially performed during the playing of the game.

In the slot machine having the above-mentioned constitution, when the player wins the bonus game, the winning state is stocked. Then, in a state that the bonus game is stocked, when the player touches the touch panel 3a and a stock release command is inputted to the main CPU 32, the stocked bonus game is executed. That is, the bonus game is not executed in accordance with the game processing steps on the gaming machine side but is executed at desired timing by the will of the player (inputting manipulation of the stock release command) and hence, the player can positively participate in the game and can play the game with strategy and interest.

For example, the player may reserve the right to perform the bonus game for a period as long as possible and may enjoy the bonus game later or may acquire the sense of superiority by showing off a large quantity of acquired coins to viewers around the player.

Further, in this embodiment, the predetermined condition is set as the number of times of stocked bonus game, and when the number of times of stocked bonus game becomes X times or more, the content of the bonus game is changed. By setting such a condition, the content of the bonus game executed in releasing the stocked bonus game is changed and hence, the player plays the game aiming at such a condition thus largely expanding the horizon of the interest and the game properties.

Further, in this embodiment, with respect to the changed bonus game which is executed when the predetermined condition is established, the high award bonus game which gives the player the larger number of coins than the number of coins acquired based on the number of times of stocked bonus game is executed and hence, the execution of the bonus game after the establishment of the predetermined condition gives a merit to the player. Accordingly, the player plays the game aiming at such a high award bonus game thus largely expanding the horizon of the interest and the game property.

Here, the above-mentioned predetermined condition may be suitably modified. For example, the predetermined condition may be grasped per the number of times of game and when the number of times of game up to the present time from starting of the game exceeds a predetermined value, the content of the bonus game may be changed. For example, the number of times of start reception processing is counted and is written in the RAM 33, and at a stage that the number of times of start reception processing exceeds the predetermined value, the content of the bonus game may be changed.

To be more specific, as described in the flowchart of the bonus game credit processing shown in FIG. 11, when the player touches the above-mentioned touch panel 3a, the bonus game is executed based on such touching of the touch panel 3a (S41, YES). In this case, unless the bonus game is credited, even when the player touches the touch panel 3a, the bonus game credit processing is not executed and the processing is shifted to the processing in S1 shown in FIG. 6 (S42, YES).

In the bonus game credit processing, when the number of times of game written in the RAM 33 is equal to or more than the predetermined value (Y) or more, that is, when the predetermined condition is established (S43, YES), the above-mentioned high award bonus game processing which is a bonus game whose content is changed from the content of the usual bonus game is executed (S44). On the other hand, when the predetermined condition is not established (S43, NO), the content of the bonus game is not changed from the usual bonus game and the usual bonus game whose number of times amounting to the number of times of credit is executed (S45).

In this manner, the predetermined condition can be properly changed. Further, it may also possible to suitably change the predetermined condition such that the number of inserted coins is used as the predetermined condition or the gaming time (time which reaches the present from starting of the game) may be set as the predetermined condition.

Further, a plurality of such predetermined conditions may be set and the content of the bonus game may be changed for every condition. For example, as described in the flowchart shown in FIG. 12, when the player touches the above-mentioned touch panel 3a, the bonus game is executed based on the touching of the touch panel 3a (S51, YES). In this case, unless the bonus game is credited, even when the player touches the touch panel 3a, the bonus game credit processing is not executed and the processing is shifted to the processing in S1 shown in FIG. 6 (S52, YES).

In the bonus game credit processing, if the number of establishments of bonus game (credit number (X)) written in the RAM 33 is equal to or more than the predetermined value, that is, if the first predetermined condition is established (S53, YES), it is subsequently determined whether the accumulated number of times of game which is the second predetermined condition is equal to or more than the predetermined value (Y) or not (S54). Then, if the number of times of game is equal to or more than the predetermined value (Y), that is, the second predetermined condition is established (S54, YES), the above-mentioned high award bonus game A which is a bonus game whose content is changed from the content of the usual bonus game is executed (S55). On the other hand, if the second predetermined condition is not established (S54, NO), the high award bonus game whose content is changed from the content of the usual bonus game and the content of the high award bonus game A is executed (S56).

Here, in the above-mentioned S53, if the first predetermined condition is not established, the usual bonus game corresponding to the number of times of credit is executed (S57).

As described above, with respect to the above-mentioned predetermined condition, the plurality of predetermined conditions may be set. Corresponding to the setting of the plurality of predetermined conditions, the content of the high award bonus game executed corresponding to the predetermined conditions, the content may be changed for every predetermined condition. By setting the plurality of predetermined conditions in this manner, the player can determine whether the stock releasing is to be performed or not for every establishment of the predetermined condition and hence, the player can play the game with the further sophisticated strategy and the interest and the game property of the game are further largely expanded.

Although the embodiment of the present invention has been explained, the present invention is not limited to the above-mentioned embodiment and various modifications can be made as follows.

In the above-mentioned embodiment, with respect to the bonus game which is performed when the predetermined condition is established, the high award bonus game which increases the awards than the usual bonus game is executed. To the contrary, it may be possible to execute a game whose awards become smaller than the awards of the usual bonus game when the predetermined condition is established. That is, by setting such a condition, for example, in a gaming machine of a mode in which a payout ratio is specified to some extent, by setting the awards when another predetermined condition is established smaller than the usual bonus game, it is possible to enhance the excitement of the game.

Further, in the above-mentioned embodiment, when the bonus game is established, the main CPU automatically stocks the number of times of the bonus game and the stocked bonus game is executed based on the will of the player. However, the stocking of the bonus game may be also performed based on the will of the player. That is, the player may freely select a stock mode and a non-stock mode of the bonus game based on the button manipulation (in the latter mode the game may be played in the same state as the usual gaming machine).

The gaming mode or the gaming steps of the above-mentioned base game, bonus game (bonus game) and high award bonus game may be suitably modified besides the above-mentioned embodiment. That is, the game may be played in various gaming modes. In the above-mentioned base game, for example, it may be possible to adopt a gaming mode in which odds of the awards is rewritten with a predetermined probability in lottery processing. In the bonus game, for example, it may be possible to adopt the constitution in which a plurality of reel groups (a multi reel group) are provided and each reel group is constituted of nine (3×3) reels thus increasing a winning ratio in the free game.

In this manner, by changing the content of the base game and the gaming mode of the bonus game and the high award bonus game in a versatile manner, it is possible to provide the gaming machine which gives more interest and excitement to the player.

Further, in executing the stocked bonus game or in executing the high award bonus game, it may be possible to perform an effect which differs from an effect of the base game (for example, an effect to visualize the bonus game or the high award bonus game with a lamp or the like or an effect which uses sounds from a speaker for making the bonus game or the high award bonus game outstanding). By performing such an effect, the player can appeal the winning of the bonus game or the high award bonus game to people around the player and, at the same time, has the sense of superiority.

Further, in the above-mentioned embodiment, the slot machine having nine display areas 3A to 3I is exemplified as the gaming machine. However, the gaming machine may be a so-called three reel slot machine or a five reel slot machine which have three and five display areas respectively. The valuable display device may be a mechanical reel. Further, the present invention is applicable to various gaming machines in which the base game and the bonus game are present, for example a card gaming machine, a pachinko machine or the like.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A gaming machine comprising:
a display unit that is configured to display a plurality of symbols;
an operation unit that allows a player to input commands; and
a processor that is operable with the display unit and the operation unit to:
execute a base game by using the symbols;
determine whether or not a bonus game is won based on a result of the base game;
allow the bonus game to be stocked to be executed afterward when it is determined that the bonus game is won;
accept a stock release command input by the player through the operation unit while the bonus game is stocked;
provide the bonus game to the player when the stock release command is accepted; and
change a content of the bonus game when a predetermined condition is established in executing the bonus game in response to inputting of the stock release command.

2. A gaming machine according to claim 1, wherein the processor, in executing the stocked bonus game, changes the content of the bonus game to a high award bonus game which gives a quantity of gaming value far larger than a gaming value acquired based on the number of times of the stocked bonus game.

3. A gaming machine according to claim 1, wherein the processor is capable of informing the player of the establishment of the predetermined condition.

4. A gaming machine according to any one of claim 1, wherein the predetermined condition is constituted of a plurality of conditions and content of the bonus game is changed for every condition.
